(19) United States
(12) Patent Application Publication
(10) Pub. No.: US 2014/0095202 A1
(43) Pub. Date: Apr. 3, 2014

(54) MEDICATION EFFECT PREDICTION SYSTEM AND CONTROL METHOD THEREOF

(71) Applicant: FUJIFILM Corporation, Tokyo (JP)

(72) Inventors: Yuuya KUDOU, Tokyo (JP); Satoshi Ueda, Tokyo (JP); Kiyohisa Okusu, Tokyo (JP); Hironori Matsumasa, Tokyo (JP); Yasunori Ohta, Ashigarakami-gun (JP)

(73) Assignee: FUJIFILM Corporation, Tokyo (JP)

(21) Appl. No.: 14/033,186

(22) Filed: Sep. 20, 2013

(30) Foreign Application Priority Data
Sep. 28, 2012 (JP) 2012-216106

(51) Int. Cl. G06F 19/00

(52) U.S. Cl. CPC G06F 19/363
USPC 705/3

(57) ABSTRACT

When a notice of medication completion, which indicates completion of medication to a patient, is transmitted from an electronic medical chart server, a medication effect information transmission device collects medication effect information relating to a medication effect on the patient from an image server and an electronic medical chart server. The medication effect information transmission device transmits and stores the collected medication effect information to a medication effect information database. A client terminal searches a medication effect information server on a basis of a drug's name and attribute data of the patient. The medication effect information server transmits average medication effect information, which represents an average medication effect of the designated drug, to the client terminal. The client terminal displays the average medication effect information in a time series on a monitor.

### BACKGROUND OF THE INVENTION

1. Field of the Invention

The present invention relates to a medication effect prediction system that predicts an effect of administration of a drug to a patient, and a control method of the medication effect prediction system.

2. Description Related to the Prior Art

In a medical institution such as a hospital and a clinic, an electronic medical chart system becomes widespread, which produces and manages attribute data including a patient's name and age, a medical record including an examination and treatment history, drug prescription data, and the like as an electronic medical chart. Also, it is attempted to use information of the electronic medical chart managed by the electronic medical chart system for diagnosis and treatment of another new patient.

For example, US Patent Application Publication No. 2006/0241978 (corresponding to Japanese Patent Laid-Open Publication No. 2006-302113) discloses an electronic medical chart system that includes an electronic medical chart database for storing patients' examination data, clinical data, and treatment data, a data matching mechanism for choosing a similar case, and a display mechanism. The data matching mechanism chooses one or more cases having data similar to data of a patient under treatment out of the past cases stored in the electronic medical chart database. The display mechanism displays medical chart information of the chosen similar case.

Japanese Patent Laid-Open Publication No. 2007-287027 discloses an electronic medical chart system that includes an interest area setting means, a similar case retrieving means, and a case information displaying means. The interest area setting means sets an interest area in a plurality of medical images captured in time series. The similar case retrieving means retrieves case information that includes a case image having a feature similar to a feature of the set interest area from a database. The case information displaying means displays an examination and treatment history of the retrieved case information in time series to support making a medical plan.

In medical prescription, a physician explains to a patient about both beneficial and adverse effects of a drug, and asks for the patient's approval for the prescription. The physician has a good knowledge of the beneficial and adverse effects of individual drugs, but has no numerical knowledge about how administration of the drug concretely treats the patient's condition. The patient often cannot imagine how the drug changes his/her condition, even if he/she receives an explanation of the drug. Thus, the patient generally approves the medical prescription as is suggested by the physician. As a result, informed consent, which stipulates that the prescription should be issued with understanding of the patient, does not work in the true sense in actual medical practice.

Since the above electronic medical chart systems retrieve and show the similar past case, it is possible for the physician to make a prescription of the patient under treatment with referring to a drug prescribed in the past case, or to use the past case in explanation to the patient. The above electronic medical chart systems, however, cannot tell how administration of the drug changes the patient's condition.

### SUMMARY OF THE INVENTION

An object of the present invention is to provide a medication effect prediction system that can predict how administration of a drug changes a patient's condition, and a control method of the medication effect prediction system.

To achieve the above and other objects, a medication effect prediction system according to the present invention includes a medication effect information database, a medication effect information retriever, an average medication effect information generator, and a display controller. The medication effect information database stores medication effect information of past patients on a patient-by-patient basis. The medication effect information relates to attribute data of the past patient, a name of a drug administered to the past patient, and an effect of the drug on the past patient. The medication effect information retriever searches the medication effect information database on a basis of a name of a drug to be administered to a patient requiring treatment and attribute data of the patient requiring treatment, and obtains the medication effect information of one or more of past patients whose attribute data is similar to the attribute data of the patient requiring treatment out of the past patients who took the same drug as the drug to be administered. The average medication effect information generator produces average medication effect information representing an average medication effect of the drug to be administered based on the medication effect information obtained by the medication effect information retriever. The display controller displays the average medication effect information in time series on a monitor.

The average medication effect information generator preferably lines up the medication effect information of a plurality of past patients obtained by the medication effect information retriever at a date of starting medication in an equal time series, to calculate the average medication effect information.

The medication effect information preferably includes at least one of examination data and vital sign data of the past patient after administration of the drug and subjective data relating to a subjective response assessed by the past patient to an effect of administration of the drug.

The display controller preferably displays the average medication effect information in a graph form along a time axis. The display controller preferably displays maximum and minimum values of the average medication effect information. The display controller preferably displays the medication effect information of a plurality of past patients whose attribute data is more similar to the attribute data of the patient requiring treatment, out of the medication effect information of a plurality of past patients used for producing the average medication effect information.

It is preferable that the medication effect prediction system further includes a time designator for designating arbitrary time in the average medication effect information. The display controller displays the average medication effect information of the designated time. The average medication effect information of the designated time may include a medical image. The medical image is medical images of a plurality of past patients whose attribute data is more similar to the attribute data of the patient requiring treatment, out of the medication effect information of a plurality of past patients used for producing the average medication effect information.

The medication effect information retriever preferably retrieves a generic drug having similar composition to composition of the drug to be administered and the medication effect information of the generic drug. The display controller preferably displays in a time series on the monitor the average medication effect information of the generic drug, together with the average medication effect information of the drug to be administered.

It is preferable that the medication effect prediction system further includes a medication effect information transmission device. The medication effect information transmission device may include a medication effect information collector, a standardizer, and a medication effect information transmitter. The medication effect information collector collects the medication effect information from an electronic medical chart server, which manages the attribute data, diagnosis and treatment data, and examination data of the past patients after completion of treatment. The standardizer standardizes the medication effect information collected by the medication effect information collector. The medication effect information transmitter transmits the medication effect information standardized by the standardizer to a medication effect information server. The medication effect information server manages the medication effect information database. The medication effect information collector preferably starts collecting the medication effect information, when a notice of medication completion for indicating completion of medication to the patient is transmitted from the electronic medical chart server.

A control method of a medication effect prediction system includes the steps of searching a medication effect information database on a basis of a name of a drug to be administered to a patient requiring treatment and attribute data of the patient requiring treatment, and obtaining medication effect information of one or more of past patients whose attribute data is similar to the attribute data of the patient requiring treatment out of the past patients who took the same drug as the drug to be administered; producing average medication effect information representing an average medication effect of the drug based on the obtained medication effect information; and displaying the average medication effect information in a time series on a monitor.

According to the present invention, the medication effect information database is searched on a basis of the attribute data of the patient requiring treatment. The medication effect information of one or more past patients whose attribute data is similar to that of the patient requiring treatment is obtained, and the average medication effect information is calculated from the obtained medication effect information. Thus, it is possible to predict the effect of medication. The average mediation effect information is displayed in a time series on the monitor, so it is possible to easily grasp change in the patient's condition due to the medication.

### BRIEF DESCRIPTION OF THE DRAWINGS

For more complete understanding of the present invention, and the advantage thereof, reference is now made to the subsequent descriptions taken in conjunction with the accompanying drawings, in which:

FIG. 1 is a schematic view of an example of a medication effect prediction system;

FIG. 2 is an explanatory view showing a format of a notice of medication completion;

FIG. 3 is a block diagram of a medication effect information transmission device;

FIG. 4 is an explanatory view showing a format of a delivery request;

FIG. 5 is an explanatory view of medication effect information;

FIG. 6 is a block diagram of a client terminal;

FIG. 7 is an explanatory view of a retrieval condition screen;

FIG. 8 is an explanatory view showing a format of a retrieval request;

FIG. 9 is an explanatory view of a medication effect information database;

FIG. 10 is a block diagram of a medication effect information server;

FIG. 11 is a graph showing an example of the medication effect information retrieved by a medication effect information retriever;

FIG. 12 is a graph showing a state in which a medication period of the medication effect information of FIG. 11 is equalized;

FIG. 13 is a graph showing average medication effect information obtained from the medication effect information of FIG. 12;

FIG. 14 is an explanatory view of a medication effect information display screen;

FIG. 15 is an explanatory view of the medication effect information display screen in which details of the average medication effect information are displayed;

FIG. 16 is an explanatory view of the medication effect information display screen having a time designation frame;

FIG. 17 is an explanatory view of the medication effect information display screen having designated time medication effect information;

FIG. 18 is an explanatory view of the medication effect information display screen having medical images;

FIG. 19 is a flowchart of a collection procedure of the medication effect information;

FIG. 20 is a flowchart of retrieval and display procedures of the medication effect information;

FIG. 21 is an explanatory view of a retrieval condition screen according to a second embodiment;

FIG. 22 is an explanatory view showing a format of a retrieval request according to the second embodiment;

FIG. 23 is a block diagram of a medication effect information server according to the second embodiment; and

FIG. 24 is an explanatory view of a medication effect information display screen according to the second embodiment.

### DESCRIPTION OF THE PREFERRED EMBODIMENTS

### First Embodiment

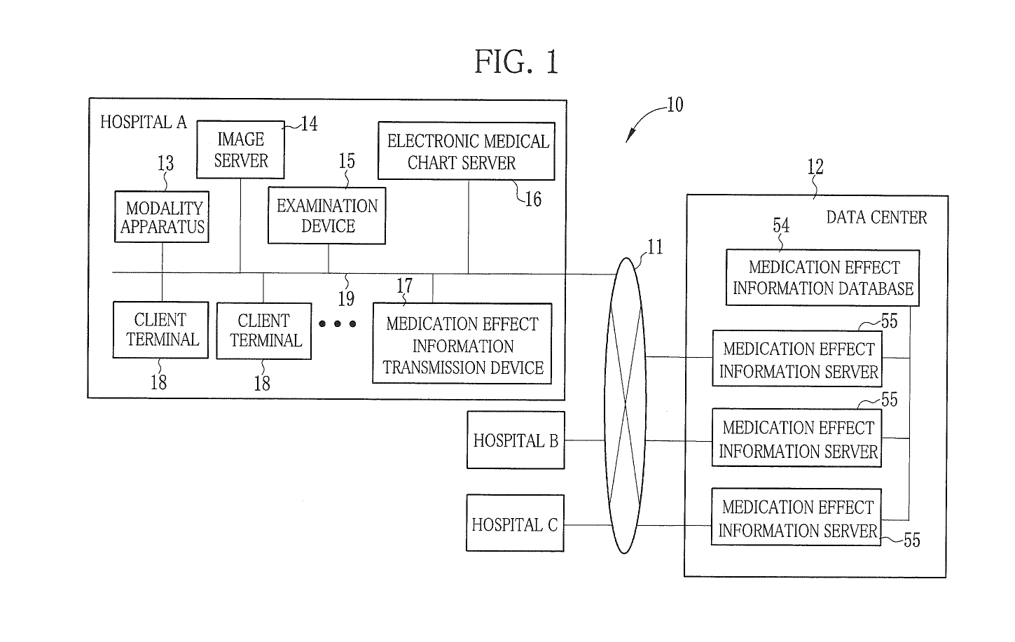

As shown in FIG. 1, a medication effect prediction system 10 is constituted of a plurality of hospitals A, B, and C and a data center 12 connected to the hospitals A, B, and C through the Internet 11. The data center 12 manages medication effect information transmitted from the hospitals A to C. The medication effect information is information about the medication effects of individual drugs on patients. When the hospital A, B, or C makes an inquiry about a medication effect of a certain drug, the data center 12 produces average medication effect information of the drug, and transmits the average medication effect information to the hospital A, B, or C. The hospital A, B, or C uses the average medication effect information for reference in choosing a drug to be prescribed or in explaining prescription to a patient.

Since the hospitals A, B, and C have the same or similar structure, only the hospital A will be hereinafter described. The hospital A is provided with a modality apparatus 13, an image server 14, an examination device 15, an electronic medical chart server 16, and a medication effect information transmission device 17, and a plurality of client terminals 18. The modality device 13 takes medical images. The image server 14 manages the medical images taken with the modality apparatus 13. The examination device 15 examines a specimen e.g. blood of the patient. The electronic medical chart server 16 manages an electronic medical chart. The medication effect information transmission device 17 collects the medication effect information from the above components 13 to 16, and transmits the medication effect information to the data center 12. The client terminals 18 are used for displaying the medical images, the electronic medical chart, and the medication effect information, and producing the electronic medical chart. These components 13 to 18 are communicatably connected through a LAN 19. The LAN 19 is connected to the Internet 11.

The modality apparatus 13 is a CR apparatus, a DR apparatus, or the like, for example. The CR apparatus captures an X-ray image on an imaging plate to which a stimulated phosphor is applied. After that, the X-ray image captured on the imaging plate is read out as electronic data by scanning the imaging plate. The DR apparatus captures an X-ray image using a flat panel detector (FPD) having a matrix of pixels each of which accumulates signal charge by an amount corresponding to an incident X-ray amount. The signal charge is accumulated on a pixel-by-pixel basis, and converted into a voltage signal by its signal processing circuit to detect the X-ray image as electronic data.

The image server 14 is composed of a computer on which a control program is installed and a database connected to the computer. The medical images taken by the modality apparatus 13 are transmitted to the image server 14 through the LAN 19. The image server 14 stores the medical images transmitted from the modality apparatus 13 to its database. The modality apparatus 13 writes a patient ID and the like as metadata to each medical image. The image server 14 retrieves the medical image using the metadata as a key.

In response to a delivery request from the medication effect information transmission device 17 or a view request from the client terminal 18, the image server 14 retrieves the medical image from its database based on the patient ID included in the delivery request or the view request. The retrieved medical image is transmitted to the medication effect information transmission device 17 or the client terminal 18.

The examination device 15 is a quantitative analysis device for analyzing a chemical or electrolytic composition of the specimen such as blood or urine, an immune serum examination device for performing quantitative analysis of the presence, the absence, or the ratio of antigen and antibody in the specimen, a blood examination device for analyzing a blood cell component, hemoglobin concentration, blood coagulating power, or a blood clotting factor, or the like. The examination device 15 transmits examination results to the electronic medical chart server 16.

The electronic medical chart server 16 includes a computer on which a control program is installed and a database connected to this computer. Electronic medical chart information inputted from the client terminals 18 and the examination results sent from the examination device 15 are transmitted to the electronic medical chart server 16 through the LAN 19. The electronic medical chart server 16 stores the electronic medical chart information and the examination results to its database.

The electronic medical chart information includes attribute data, diagnosis and treatment data, and examination data, for example. The attribute data is personal data of an individual patient including a patient's name, the patient ID, a postal address, a birthday, an age, a sex, a family structure, the presence or absence of a preexisting condition and an allergy, and the like. The diagnosis and treatment data includes dates of diagnosis and treatment, a clinical department, a name of disease, a diagnosis result, a treatment period, the type and dose of medication, a name of pharmacy, and the like. The treatment period is the time period over which the patient visits the hospital for a single disease. The examination data includes image data of the medical image that is taken by the modality apparatus 13 to make the diagnosis, a result of examination performed by the examination device 15, and the like. The examination data also includes an examination date, a name of an examination apparatus, an examination method, a body part to be examined, and the like.

The examination data includes subjective data of the patient evaluating the medication effect on a scale of “1” to “5”, for example. The subjective data is obtained from the patient using an interview sheet or by history taking by the physician. The subjective data obtained from the patient is written to the electronic medical chart information of the patient as one item of the examination data.

In response to the delivery request from the medication effect information transmission device 17 or the view request from the client terminal 18, the electronic medical chart server 16 retrieves the electronic medical chart of a patient from its database based on the patient ID included in the delivery request or the view request. The retrieved attribute data, diagnosis and treatment data, and examination data are transmitted to the medication effect information transmission device 17 or the client terminal 18. The electronic medical chart server 16 receives the electronic medical chart information inputted and transmitted from the client terminal 18, and stores the electronic medical chart information to its database.

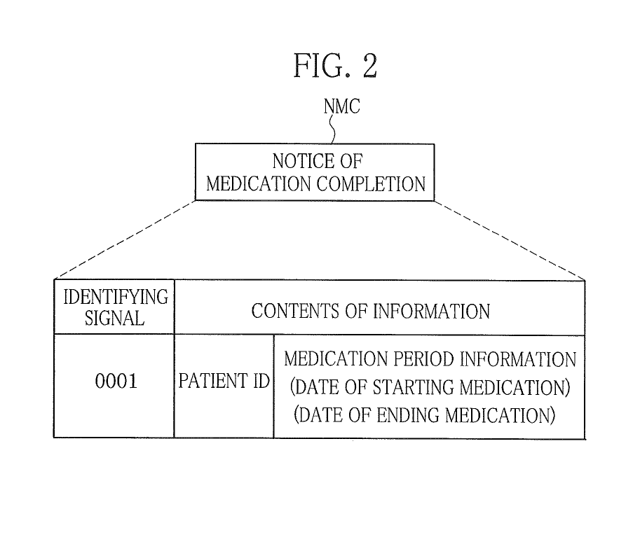

When the completion of medication to a patient is inputted to the electronic medical chart, the electronic medical chart server 16 transmits a notice of medication completion NMC to the medication effect information transmission device 17. This is because the completion of medication finalizes the medication effect information of the patient in a medication period from the start of medication to the end thereof. As shown in FIG. 2, the NMC of this embodiment includes an identifying signal “0001” specific to the NMC, a patient ID of the patient whose medication is completed, and medication period information of the patient. The medication period information includes a date of starting the medication and a date of ending the medication. The medication effect information transmission device 17 starts collecting the medication effect information based on the NMC.

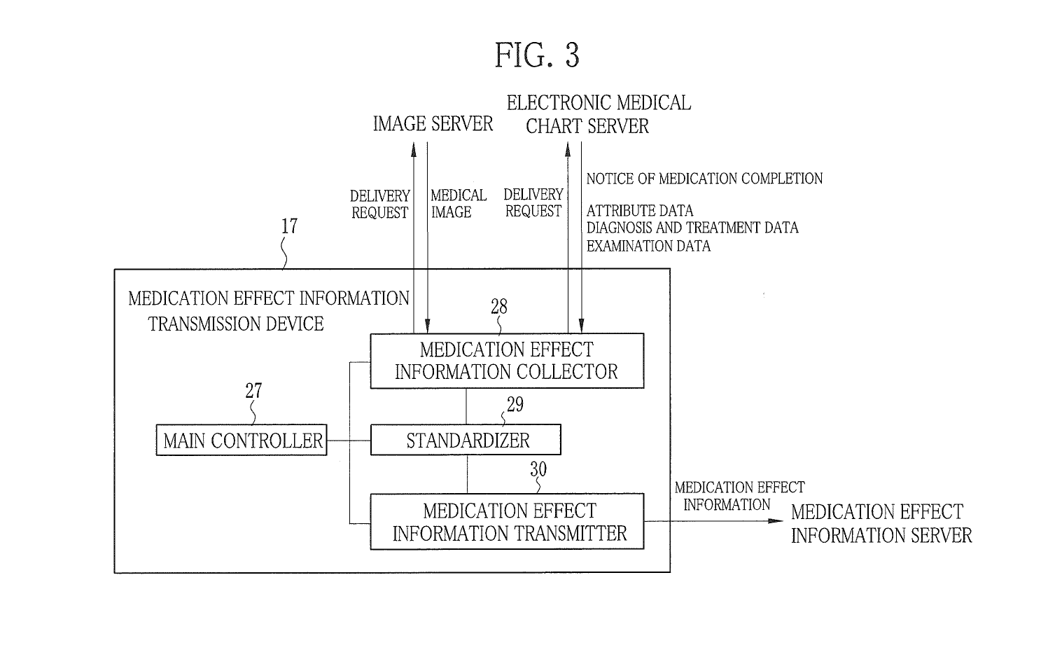

The medication effect information transmission device 17 is composed of a computer on which a medication effect information transmission program is installed. By executing the medication effect information transmission program, as shown in FIG. 3, the computer has the functions of a main controller 27, a medication effect information collector 28, a standardizer 29, and a medication effect information transmitter 30. The main controller 27 controls these components 28 to 30.

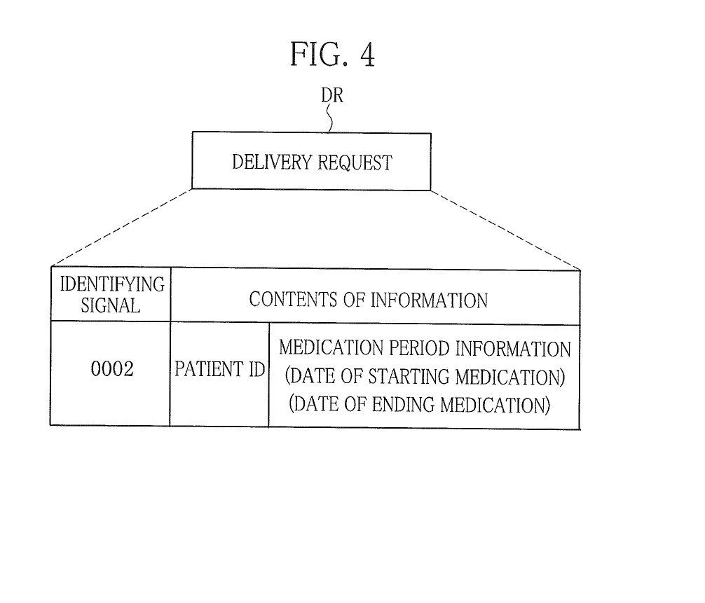

The medication effect information collector 28 collects the medication effect information from the image server 14 and the electronic medical chart server 16. When the NMC is transmitted from the electronic medical chart server 16, the medication effect information collector 28 issues a delivery request DR to the image server 14 and the electronic medical chart server 16. As shown in FIG. 4, the DR of this embodiment includes an identifying signal “0002” specific to the DR and the patient ID and the medication period information that are read out of the NMC.

Upon receiving the DR, the image server 14 retrieves one or more medical images taken within the medication period out of the medical images of a patient having the patient ID specified in the DR, and transmits the medication effect information including the retrieved medical images to the medication effect information transmission device 17.

Upon receiving the DR, the electronic medical chart server 16 retrieves the medication effect information obtained in the medication period out of the electronic medical chart information of a patient having the patient ID specified in the DR, and transmits the retrieved medication effect information to the medication effect information transmission device 17. Thus, the medication effect information collector 28 receives the medication effect information from the image server 14 and the electronic medical chart server 16.

The standardizer 29 standardizes the medication effect information, which includes the medical images, the attribute data, the diagnosis and treatment data, and the examination data and is collected by the medication effect information collector 28. The standardization is carried out on a basis of a standard set in HL7 (Health Level Seven) or DICOM (Digital Imaging and Communications in Medicine Standards Committee) or standardization data set in JAHIS (Japanese Association of Healthcare Information Systems Industry), MEDIS-DC (Medical Information System Development Center), or the like. The standardization is performed for the purpose of sharing the medication effect information among a plurality of hospitals that use the different types of modality apparatuses, image servers, and electronic medical chart servers of different makers.

The medication effect information transmitter 30 transmits the standardized medication effect information to the data center 12 through the LAN 19 and the Internet 11. In order to prevent leakage of the medication effect information on the Internet 11, the data center 12 may be connected to the hospitals A to C through a VPN (virtual private network), or the transmitted information may be encoded.

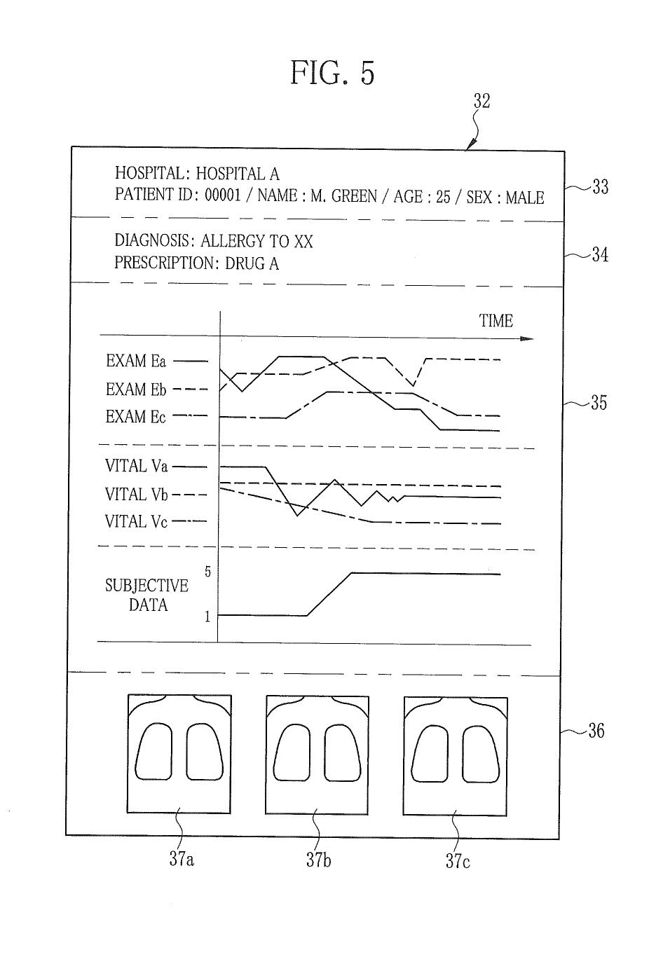

FIG. 5 shows an example of the medication effect information to be transmitted from the medication effect information transmission device 17 to the data center 12. Medication effect information 32 includes attribute data 33, diagnosis and treatment data 34, examination data 35, and image data 36. The attribute data 33 includes a patient ID, a patient's name, age, and sex, and a name of a hospital that the patient visited. The diagnosis and treatment data 34 includes a diagnosis and a drug's name. The examination data 35 includes examination results Ea, Eb, and Ec, vital sign measurement results Va, Vb, and Vc, and the patient's subjective data. The image data 36 includes medical images 37a to 37c such as X-ray images taken within the medication period.

The examination results Ea to Ec are results of examinations performed by the examination device 15, e.g. the quantitative analysis device, the immune serum examination device, or the blood examination device. The vital sign measurement results Va to Vc represent measurement results of body temperature, blood pressure, the number of pulses, and the like. Note that, the examination results Ea to Ec, the vital sign measurement results Va to Vc, and the subjective data are plotted in a graph having a time axis in the medication effect information 32. The examination results Ea to Ec, the vital sign measurement results Va to Vc, and the subjective data are data that has the correlation between time e.g. an examination date or a measurement date and an examination or measurement result.

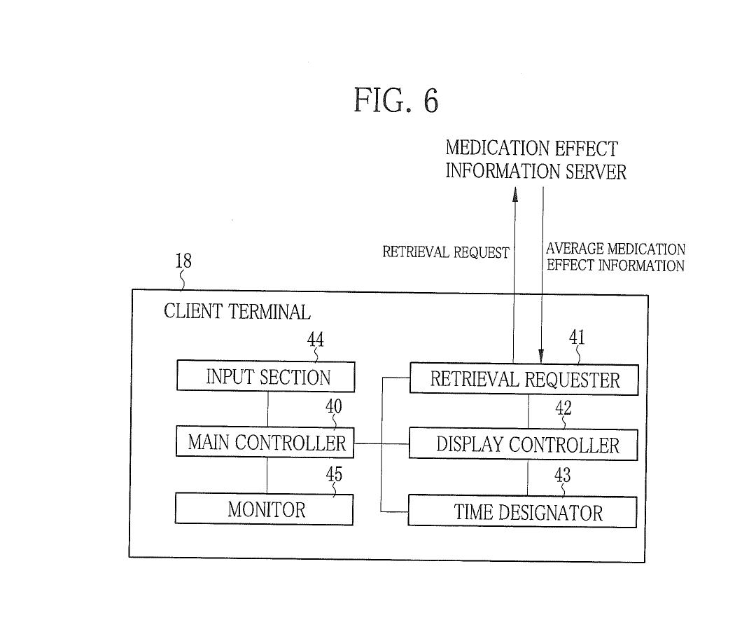

The client terminal 18 is composed of a computer on which an electronic medical chart creating program, a medical image viewing program, a medication effect information viewing program, and the like are installed. By executing the medication effect information viewing program, as shown in FIG. 6, the computer has the functions of a main controller 40, a retrieval requester 41, a display controller 42, and a time designator 43. The main controller 40 controls the components 41 to 43. The client terminal 18 is provided with an input section 44 including a keyboard, a mouse, and the like and a monitor 45 for displaying the electronic medical chart information, the medical image, the medication effect information, and the like.

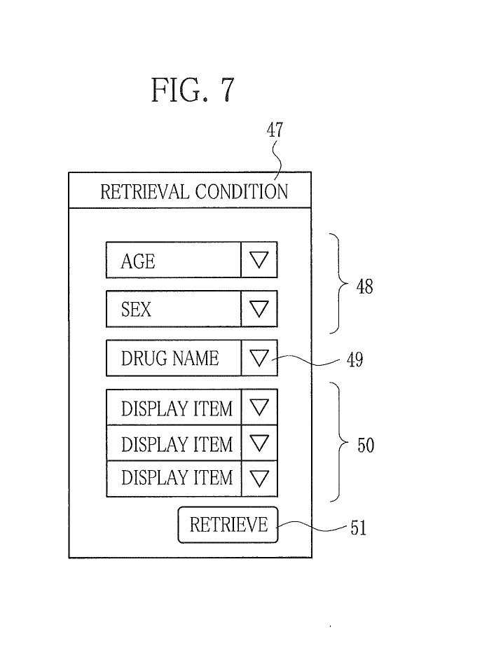

The retrieval requester 41 makes a request to the data center 12 for retrieval of the medication effect information. In response to such an operation of the client terminal 18 for the retrieval of the medication effect information, the retrieval requester 41 displays a retrieval condition screen 47 shown in FIG. 7 on the monitor 45. The retrieval condition screen 47 has attribute data input boxes 48 for inputting retrieval conditions relating to the attribute data such as the age and sex of the patient, a drug name input box 49 for inputting the drug's name, display item input boxes 50 for inputting one or more items of the medication effect information to be displayed on the client terminal 18, and a retrieve button 51 for starting the retrieval.

A specific age such as “26 years old” or “35 years old” or a generation such as “twentysomething” or “fortysomething” is inputted to the attribute data input box 48. To the display item input boxes 50, for example, one or more examination results Ea to Ec, one or more vital sign measurement results Va to Vc, the subjective data being a subjective response of the patient to the administration of the drug, or the like is inputted. Data entry to the boxes 48 and 50 is performed using the keyboard of the input section 44.

Data entry to the attribute data input boxes 48, the drug name input box 49, and the display item input boxes 50 may be performed using a pull-down button provided at a right end of each box 48, 49, or 50. When the pull-down button is clicked by the mouse of the input section 44, a plurality of candidates are listed under the box 48, 49, or 50. Out of the listed candidates, an arbitrary retrieval condition is selected by the mouse. The number of the boxes 48 to 50 is not limited to that shown in the retrieval condition screen 47 of FIG. 7. For example, the number of the attribute data input boxes 48 and the display item input boxes 50 may be increased, or arbitrarily changeable by user settings.

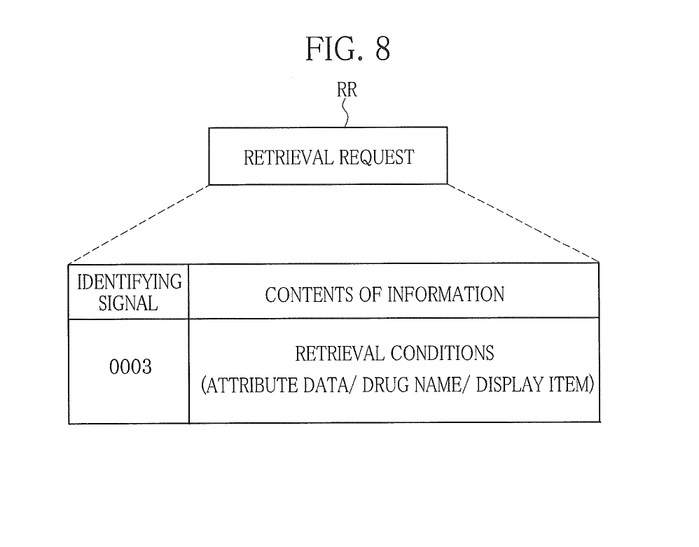

When the data entry is performed to the boxes 48 to 50 of the retrieval condition screen 47 and the retrieve button 51 is clicked, the retrieval requester 41 transmits a retrieval request RR to the data center 12. As shown in FIG. 8, the retrieval request RR of this embodiment includes an identifying signal “0003” specific to the RR and the retrieval conditions inputted to the boxes 48 to 50. Taking the case of inputting “fortysomething” and “male” to the attribute data input boxes 48, “antihistamine A” to the drug name input box 49, and “examination result Ea” and “examination result Ec” to the display item input boxes 50 as an example, the RR includes “fortysomething/male/antihistamine A/examination result Ea/examination result Ec” as the retrieval conditions.

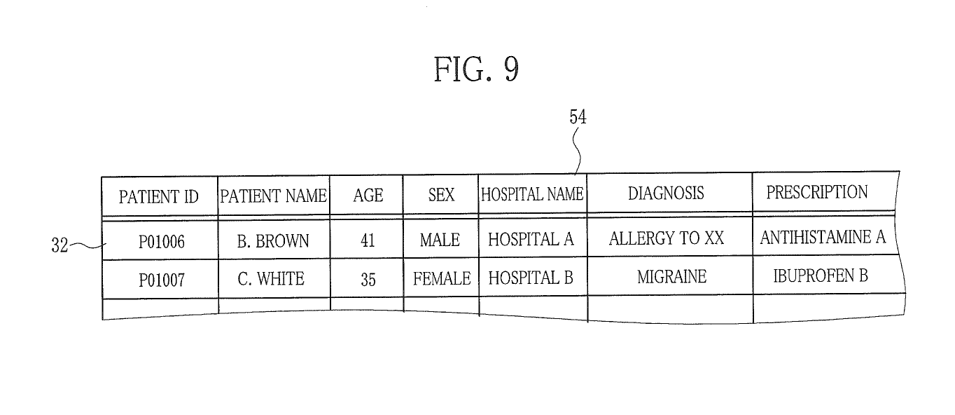

The data center 12 is provided with a medication effect information database 54, and a plurality of medication effect information servers 55 for managing the database 54. As shown in FIG. 9, the medication effect information database 54 stores medication effect information 32 transmitted from the medication effect information transmission device 17 on a patient-by-patient basis. To be more specific, the attribute data of the past patients and the drug's names administered to the past patients are stored together with the medication effect information.

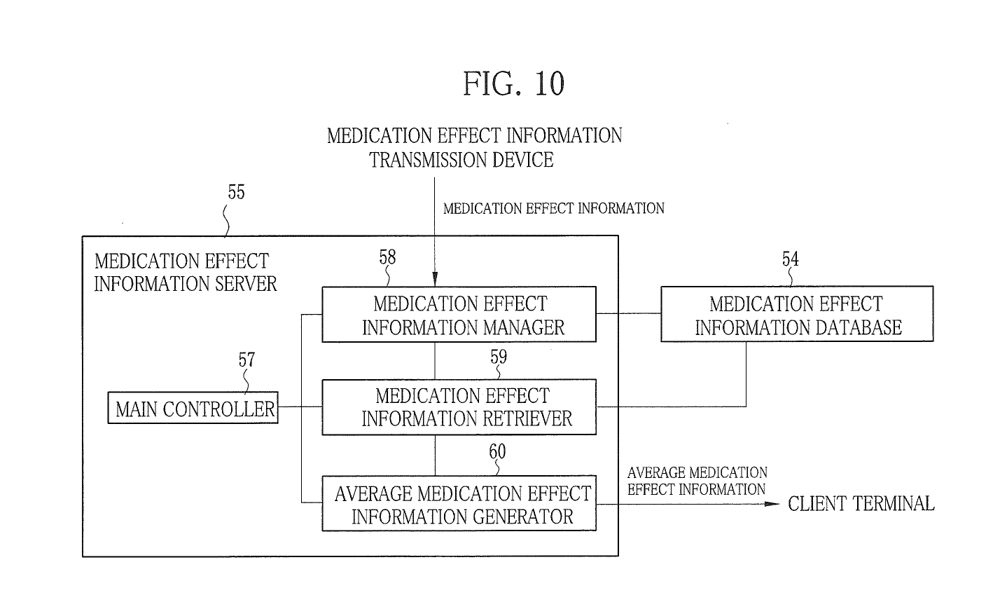

The medication effect information server 55 is a computer on which a medication effect information management program is installed. By executing the medication effect information management program, as shown in FIG. 10, the computer has the functions of a main controller 57, a medication effect information manager 58, a medication effect information retriever 59, and an average medication effect information generator 60. The main controller 57 controls the components 58 to 60. Note that, in this embodiment, there are provided three medication effect information servers 55 the number of which corresponds to the number of the hospitals A to C connected to the medication effect prediction system 10. The number of the medication effect information servers 55 may be more or less than the number of the hospitals in accordance with processing ability of the medication effect information servers 55.

The medication effect information manager 58 stores to the medication effect information database 54 the medication effect information 32 transmitted from the medication effect information transmission device 17 through the LAN 19 and the Internet 11. The mediation effect information retriever 59 retrieves information from the medication effect information database 54 based on the RR transmitted from the client terminal 18. To be more specific, the medication effect information retriever 59 retrieves past patients to which a drug designated by the RR was administered from the medication effect information database 54. Out of the retrieved past patients, a plurality of patients whose attribute data matches or is similar to the retrieval conditions designated by the RR are retrieved. Thus, the medication effect information retriever 59 retrieves the medication effect information of the several past patients of high-ranked similarity.

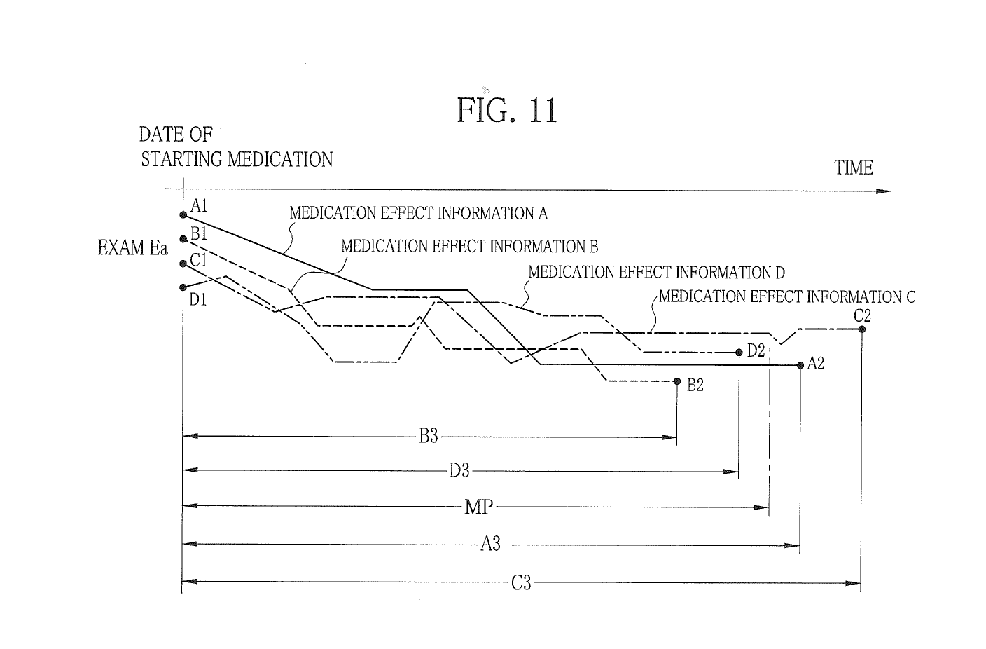

The average medication effect information generator 60 produces average medication effect information, which represents an average medication effect of the drug, based on the medication effect information retrieved by the medication effect information retriever 59. For example, FIG. 11 is a graph showing the examination result Ea of medication effect information A to D of the several past patients of high-ranked similarity, which is retrieved by the medication effect information retriever 59, in time series with starting from a date of starting medication. As is apparent from the graph, medication periods A3 to D3, each extending from a date A1 to D1 of starting medication to a date A2 to D2 of ending the medication, differ from patient to patient. Thus, the average medication effect information generator 60 lines up the medication effect information A to D at the dates A1 to D1 of starting medication in time series, and corrects the medication effect information A to D so as to equalize the medication periods A3 to D3.

More specifically, the average medication effect information generator 60 calculates an average medication period of the medication effect information A to D retrieved by the medication effect information retriever 59, and corrects the medication effect information A to D so as to equalize each of the medication periods A3 to D3 with the average medication period. Taking the case of FIG. 11 as an example, an average medication period MP is an average of the medication periods A3 to D3 of the medication effect information A to D. The average medication effect information generator 60 corrects the medication effect information A to D such that each medication period of the medication effect information A to D corresponds with the average medication period MP.

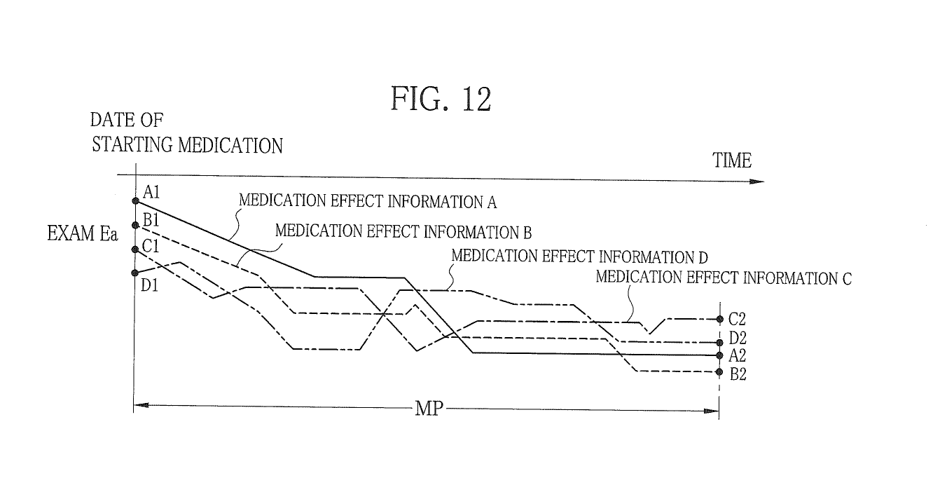

To be more specific, as shown in FIG. 12, the medication periods B3 and D3 of the medication effect information B and D are shorter than the average medication period MP, so the average medication effect information generator 60 scales up the time axis of the medication effect information B and D so as to have the average medication period MP. On the other hand, since the medication periods A3 and C3 of the medication effect information A and C are longer than the average medication period MP, so the average medication effect information generator 60 scales down the time axis of the medication effect information A and C so as to have the average medication period MP. Therefore, the medication effect information A to D has the uniform medication period MP and is lined up at the dates of starting medication.

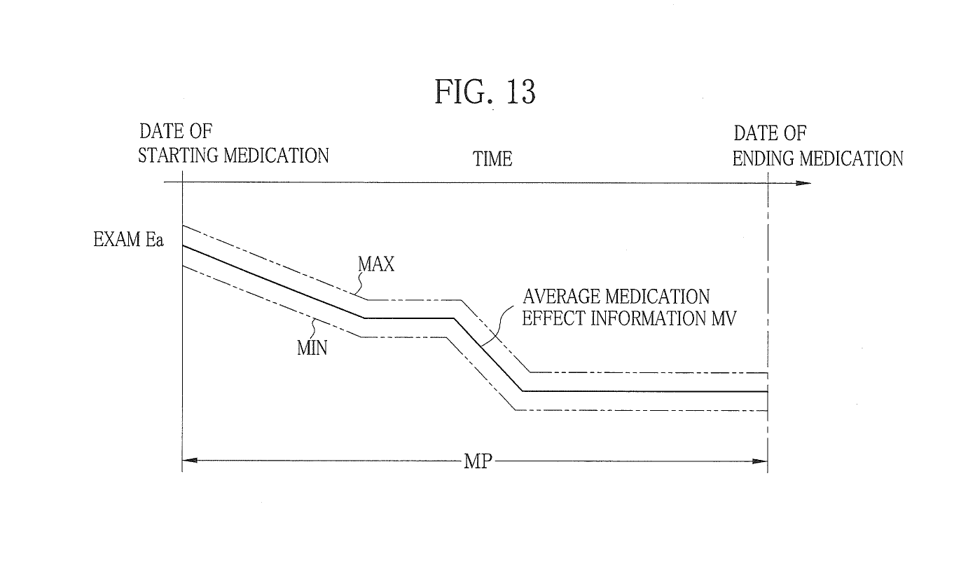

The average medication effect information generator 60 calculates an average of the medication effect information A to D with excluding data out of ±2σ, for example, and produces the average medication effect information having a certain range. As shown in FIG. 13, average medication effect information MV of the above medication effect information A to D has a certain range extending between a minimum value Min and a maximum value Max. The average medication effect information generator 60 transmits the average medication effect information MV and the original medication effect information A to D to the client terminal 18 that has issued the RR. Note that, how to obtain the average medication effect information of the examination result Ea is described above, and average medication effect information of the examination results Eb and Ec and the vital sign measurement results Va to Vc can be obtained in a like manner.

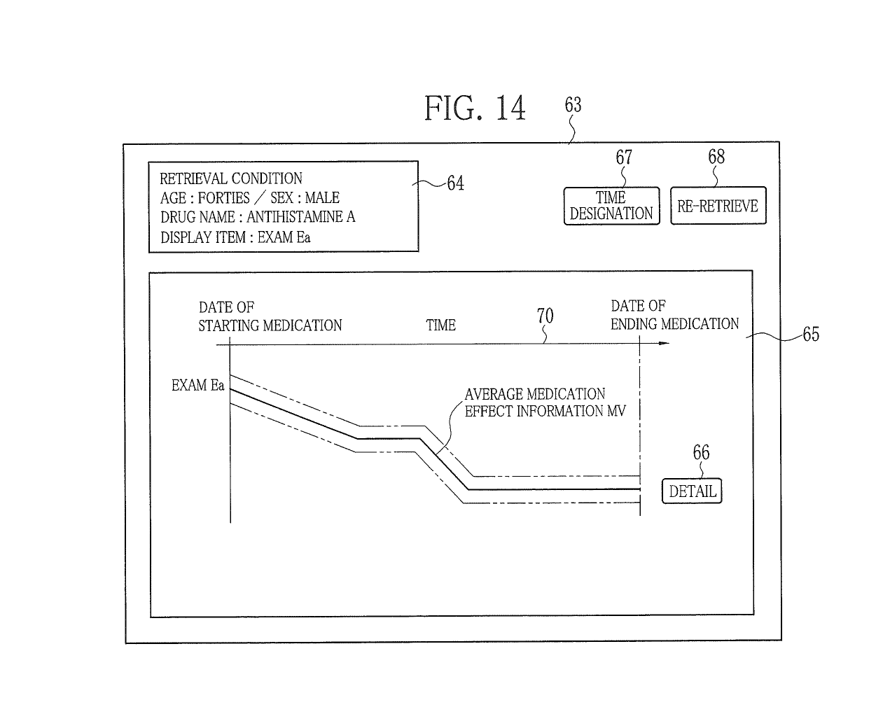

The client terminal 18 receives the average medication effect information MV transmitted from the medication effect information server 55 at its retrieval requester 41. The display controller 42 of the client terminal 18 displays the received average medication effect information MV on its monitor 45. More specifically, as shown in FIG. 14, the display controller 42 displays a medication effect information display screen 63 on the monitor 45 of the client terminal 18. The medication effect information display screen 63 is provided with a retrieval condition display section 64, a medication effect information display section 65, a detail display button 66, a time designation button 67, and a re-retrieve button 68. The re-retrieve button 68 is clicked to re-retrieve the medication effect information.

The retrieval conditions inputted to the retrieval condition screen 47 are displayed in the retrieval condition display section 64. The medication effect information display section 65 displays a time-series graph of the average medication effect information MV having a horizontal time axis 70. The average medication effect information MV includes the certain range obtained by the average medication effect information generator 60. Note that, FIG. 14 shows a case where only “examination result Ea” is designated as the display item. In a case where a plurality of display items are inputted, a plurality of graphs of the average medication effect information of the examination results Eb and Ec, the vital sign measurement results Va to Vc, and the subjective data are displayed in the medication effect information display section 65. Retrieving a plurality of drugs having similar efficacy and displaying the average medication effect information of each of the drugs in the medication effect information display screen 63 allow comparison of the medication effect between the drugs.

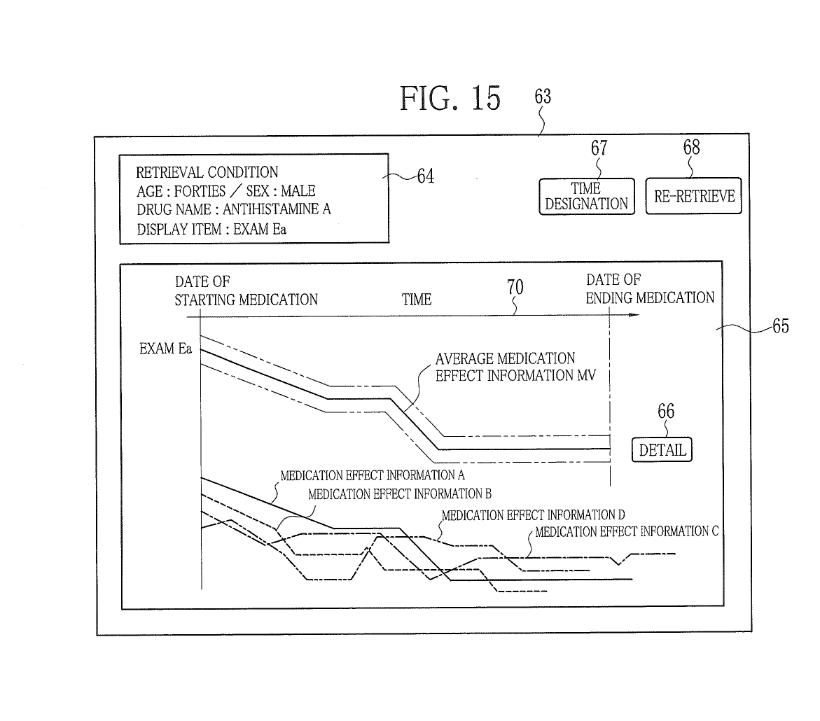

The detail display button 66 is operated to display the medication effect information of the several past patients from which the average medication effect information is obtained. Upon operation of the detail display button 66, as shown in FIG. 15, the display controller 42 displays a time-series graph of the medication effect information A to D along the time axis 70 under the graph of the average medication effect information MV. The average medication effect information MV is calculated from the medication effect information A to D.

By displaying the medication effect information A to D upon the operation of the detail display button 66, the physician can concretely confirm that how long medication period it takes for each patient to have the medication effect of the drug and how much medication effect each patient obtains. Especially, the medication effect information A to D to be displayed upon the operation of the detail display button 66 is the medication effect information of the several past patients whose attribute data is highly similar to the retrieval conditions. Thus, the physician can effectively use the medication effect information A to D for determination of the prescription or explanation of the prescription to the patient.

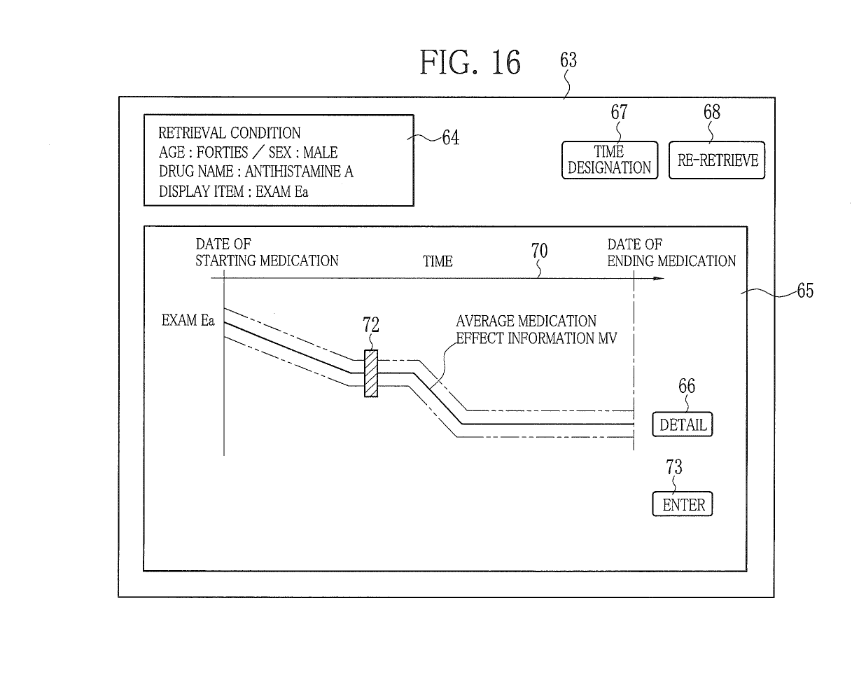

Upon operation of the time designation button 67, as shown in FIG. 16, the time designator 43 of the client terminal 18 displays a time designation frame 72 and an enter button 73 in the medication effect information display section 65. The time designation frame 72 is moved in the medication effect information display section 65 by the keyboard or the mouse of the input section 44 of the client terminal 18, and disposed in an arbitrary position of the average medication effect information MV. When the enter button 73 is operated after the movement of the time designation frame 72, designated time medication effect information at the time designated by the time designation time 72 is displayed.

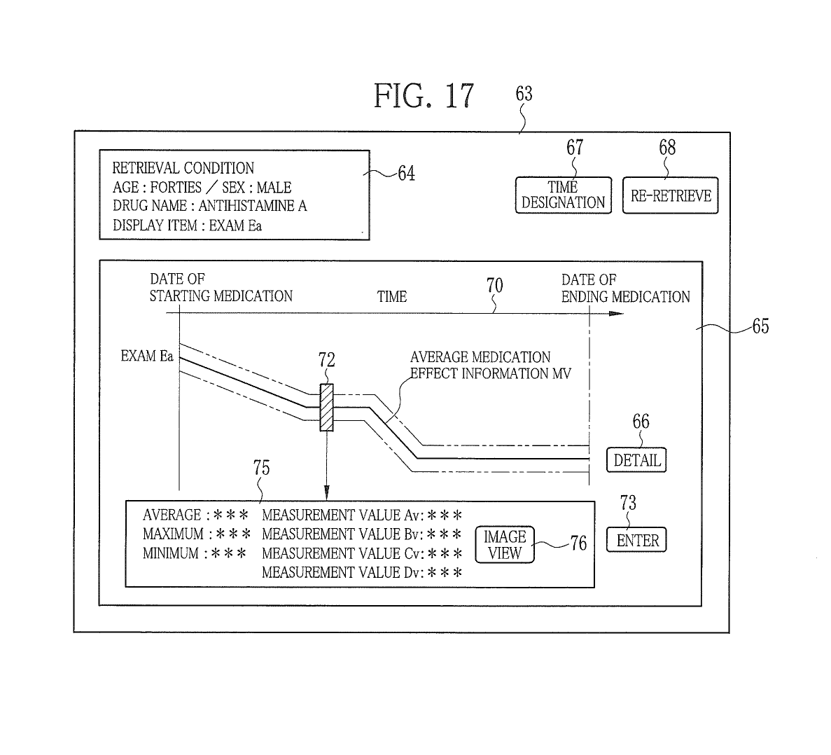

Upon the operation of the enter button 73, as shown in FIG. 17, the designated time medication effect information is displayed in a data box 75 in the medication effect information display section 65. The designated time medication effect information includes, for example, average, maximum, and minimum values of the average medication effect information MV at the designated time, measurement values Av to Dv of the medication effect information A to D from which the average medication effect information MV is calculated, and the like. In a case where there is a medical image taken at the designated time, an image view button 76 is displayed in the data box 75.

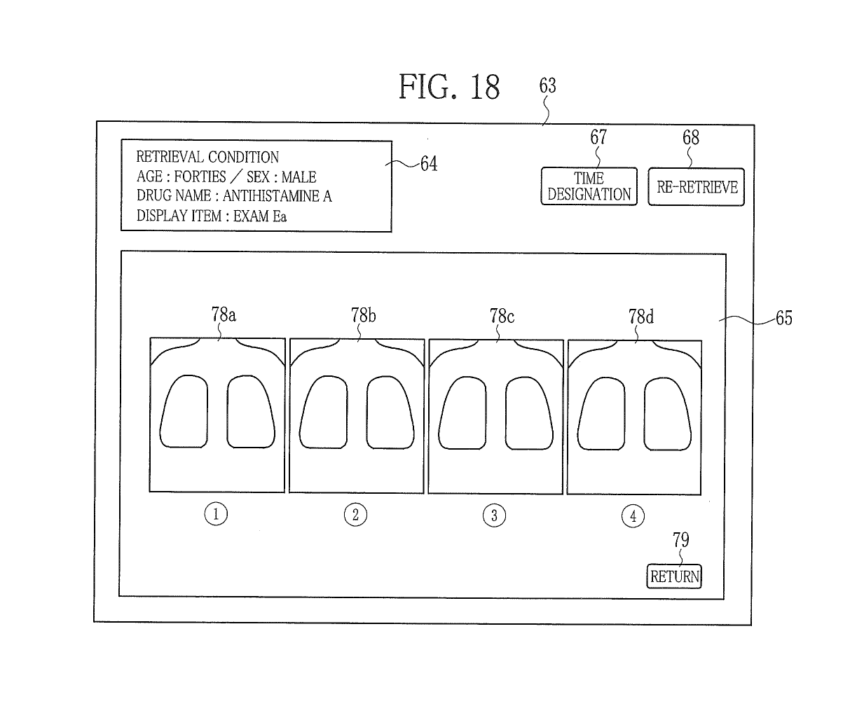

Upon operation of the image view button 76 displayed in the data box 75, as shown in FIG. 18, medical images 78a to 78d and a return button 79 are displayed in the medication effect information display section 65. When there are a plurality of medical images to be displayed in the medication effect information display section 65, similarity order to the retrieval conditions is displayed under the medical images 78a to 78d. Thus, the physician can use the medical images and the similarity order for reference in determination of the prescription or explanation of the prescription to the patient. The return button 79 is operated to return from display of the medical image to display of the average medication effect information MV.

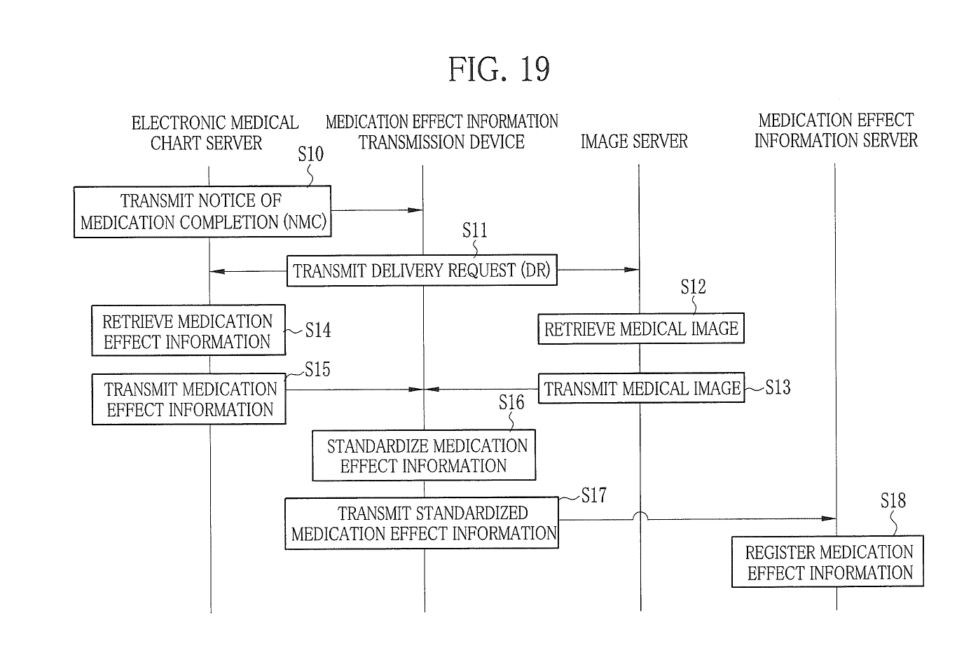

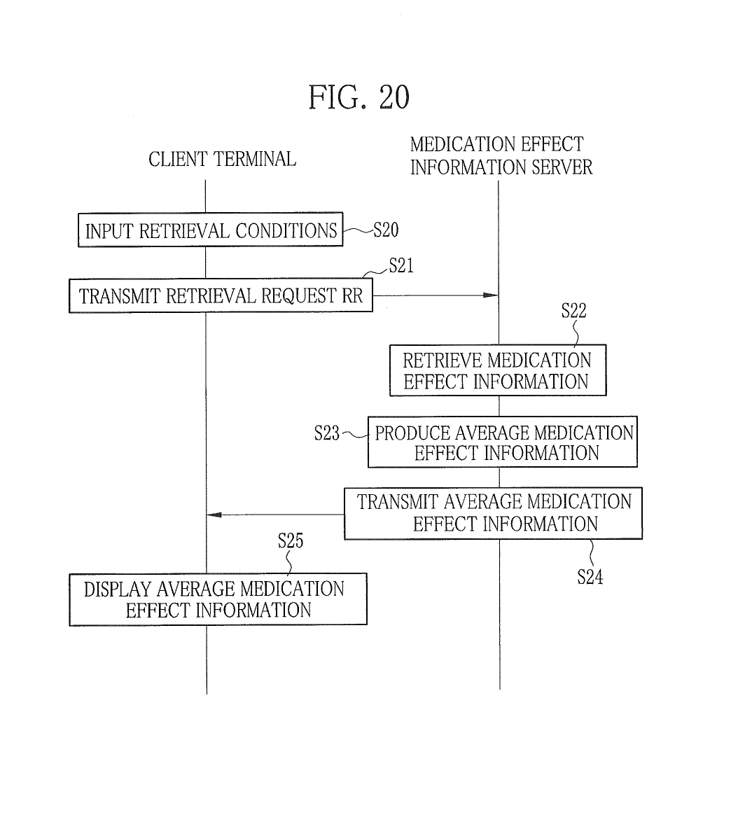

The operation of the above structure will be hereinafter described with referring to flowcharts of FIGS. 19 and 20. When the completion of medication to a patient is inputted to the electronic medical chart, the electronic medical chart server 16 transmits a notice of medication completion NMC to the medication effect information transmission device 17 (S10). Upon receiving the NMC, the medication effect information transmission device starts collecting medication effect information. The medication effect information collector 28 of the medication effect information transmission device 17 transmits a delivery request DR to the image server 14 and the electronic medical chart server 16 in order to make a request for transmission of the medication effect information (S11).

Upon receiving the DR, the image server 14 retrieves a medical image taken during a medication period, out of medical images of a patient having a patient ID included in the DR (S12). The image server 14 transmits image data including the retrieved medical image to the medication effect information transmission device 17 (S13).

Upon receiving the DR, the electronic medical chart server 16 retrieves medication effect information from the electronic medical chart information of the patient having the patient ID included in the DR (S14). The medication effect information is composed of attribute data including the patient's name, age, sex, and the like, diagnosis and treatment data including a name of disease, a prescription, and the like, and examination data including examination results and vital sign measurement values obtained during the medication period, subjective data of the patient evaluating the medication effect, and the like. The electronic medical chart server 16 transmits the retrieved medication effect information to the medication effect information transmission device 17 (S15).

The standardizer 29 of the medication effect information transmission device 17 standardizes the medication effect information transmitted from the electronic medical chart server 16 on a basis of the standard set in the HL7, the DICOM, or the like (S16). Then, the medication effect information transmission device 17 transmits the standardized medication effect information to the medication effect information server 55 (S17). The medication effect information manager 58 of the medication effect information server 55 stores to the medication effect information database 54 the medication effect information transmitted from the medication effect information transmission device 17 (S18).

When retrieval of the medication effect information is commanded, the client terminal 18 displays the retrieval condition screen 47 shown in FIG. 7 on its monitor 45. The physician enters retrieval conditions to the attribute data input boxes 48, the drug name input box 49, and the display item input boxes 50 in the retrieval condition screen 47, and operates the retrieve button 51 (S20). The retrieval requester 41 of the client terminal 18 transmits a retrieval request RR to the data center 12 based on the retrieval conditions inputted in the retrieval condition screen 47 (S21).

The medication effect information retriever 59 of the medication effect information server 55 retrieves medication effect information from the medication effect information database 54 on a basis of the RR transmitted from the client terminal 18 (S22). To be more specific, the medication effect information retriever 59 retrieves past patients to which a drug designated by the RR was administered from the medication effect information database 54. Then, the medication effect information retriever 59 retrieves the several past patients whose attribute data matches or is similar to the retrieval conditions designated by the RR, out of the retrieved past patients. The medication effect information of the several past patients of high-ranked similarity is retrieved.

The average medication effect information generator 60 of the medication effect information server 55 produces average medication effect information, which represents average medication effect of the drug, from the medication effect information retrieved by the medication effect information retriever 59 (S23). To be more specific, medication effect information A to D of the several past patients retrieved by the medication effect information retriever 59 is corrected as shown in FIG. 12 so as to equalize the medication periods A3 to D3 of the medication effect information A to D with the average medication period MP. As shown in FIG. 13, the average medication effect information generator 60 calculates an average of the corrected medication effect information A to D with excluding data out of ±2σ, and produces average medication effect information MV having to a certain range. The medication effect information server 55 transmits the average medication effect information MV and the medication effect information A to D to the client terminal 18 that has issued the RR (S24).

The display controller 42 of the client terminal 18 displays the average medication effect information MV transmitted from the medication effect information server 55 on its monitor 45 (S25). To more specific, as shown in FIG. 14, the medication effect information display screen 63 having the retrieval condition display section 64, the medication effect information display section 65, the detail display button 66, the time designation button 67, and the re-retrieve button 68 is displayed on the monitor 45.

In the medication effect information display screen 65, the horizontal time axis 70 and a time-series graph of the average mediation effect information MV along the time axis 70 are displayed. According to the average mediation effect information MV, a physician can easily understand how administration of a certain drug changes the patient's condition. Thus, the physician can use the average medication effect information MV for reference in determination of a prescription or explanation of the prescription to the patient.

Upon operation of the detail display button 66 in the medication effect information display screen 63, as shown in FIG. 15, a time-series graph of medication effect information A to D from which the average medication effect information MV is calculated is displayed along a time axis 70. The medication effect information A to D displayed upon the operation of the detail display button 66 is the medication effect information of the several past patients whose attribute data is highly similar to the retrieval conditions. Thus, the physician can effectively use the medication effect information A to D for determination of the prescription or explanation of the prescription to the patient.

Upon operation of the time designation button 67 in the medication effect information display screen 63, as shown in FIG. 16, the time designation frame 72 and the enter button 73 are displayed in the medication effect information display section 65. The physician moves the time designation frame 72 to an arbitrary position in the average medication effect information MV to designate time, and views the medication effect information at the designated time.

When the time designation frame 72 is moved to the arbitrary position in the average medication effect information MV and the enter button 73 is operated, the display controller 42 displays the data box 75 in the medication effect information display section 65, as shown in FIG. 17. In the data box 75, for example, average, maximum, and minimum values of the average medication effect information MV at the designated time, measurement values Av to Dv of the medication effect information A to D from which the average medication effect information MV is calculated, and the like are displayed.

In a case where there is a medical image taken at the designated time, the image view button 76 is displayed in the data box 75. Upon operation of the image view button 76, as shown in FIG. 18, medical images 78a to 78d are displayed in the medication effect information display section 65. Accordingly, the physician can know from the medical images that how administration of the certain drug is effective at improving the patient's condition. The average medication effect information MV, the medication effect information A to D, and the medical images displayed on the monitor 45 are used for reference in determination of a prescription or explanation of the prescription to the patient.

As described above, when the completion of medication to the patient is inputted to the electronic medical chart server 16, the medication effect information transmission device 17 automatically starts collecting the medication effect information and transmits the collected medication effect information to the medication effect information server 55, so the medication effect information of many past patients is stored to the medication effect information server 55. Since the medication effect information transmission device 17 standardizes the medication effect information before the transmission to the medication effect information server 55, it is possible to share the medication effect information among a plurality of hospitals that use the different types of modality apparatuses, image servers, and electronic medical chart servers of different makers.

Also information about the average medication effect of the drug is obtained based on the medication effect information of the past patients the attribute data of which matches or is similar to that of the patient, so it is possible to easily predict the effect of medication. This aids the physician to make a prescription. Since the average medication effect information is displayed in time series on the monitor 45, it is possible to easily grasp change in the patient's condition due to the medication. Accordingly, the patient who has obtained explanation of the prescription using the average medication effect information can easily realize the medication effect of the prescription.

### Second Embodiment

In the first embodiment, only the average medication effect information about the drug inputted in the retrieval condition screen 47 is displayed on the monitor 45. In this embodiment, unlike the first embodiment, the average medication effect information of a generic drug, which is a copy of brand-name drug, of the drug inputted in the retrieval condition screen 47 is retrieved and displayed on the monitor 45 at the same time. In this embodiment, description of components identical to those of the first embodiment will omitted, and only differences from the first embodiment will be mainly described.

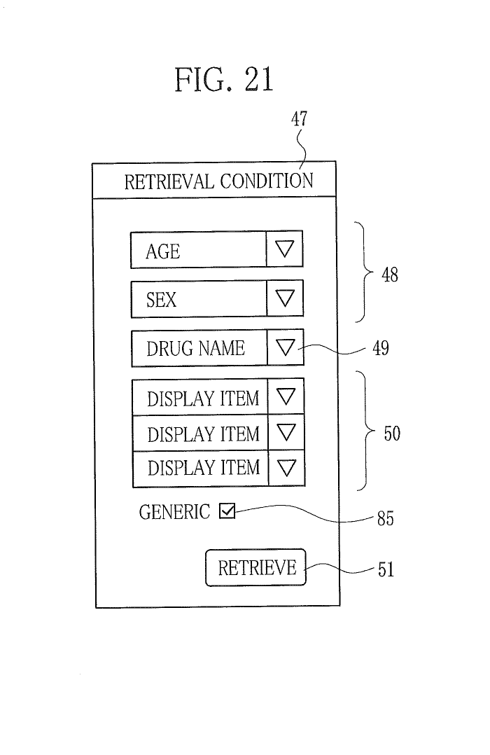

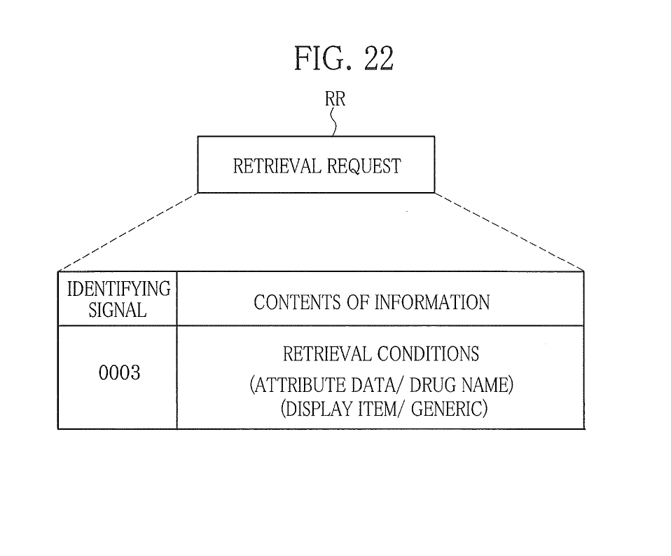

As shown in FIG. 21, the retrieval condition screen 47 of this embodiment has a check box 85 for choosing whether to retrieve the generic drug or not. The check box 85 is clicked by the mouse of the input section 44 and the retrieve button 51 is operated, as shown in FIG. 22, the generic drug is added as one of the retrieval conditions to the retrieval request RR to be transmitted from the client terminal 18 to the medication effect information server 55.

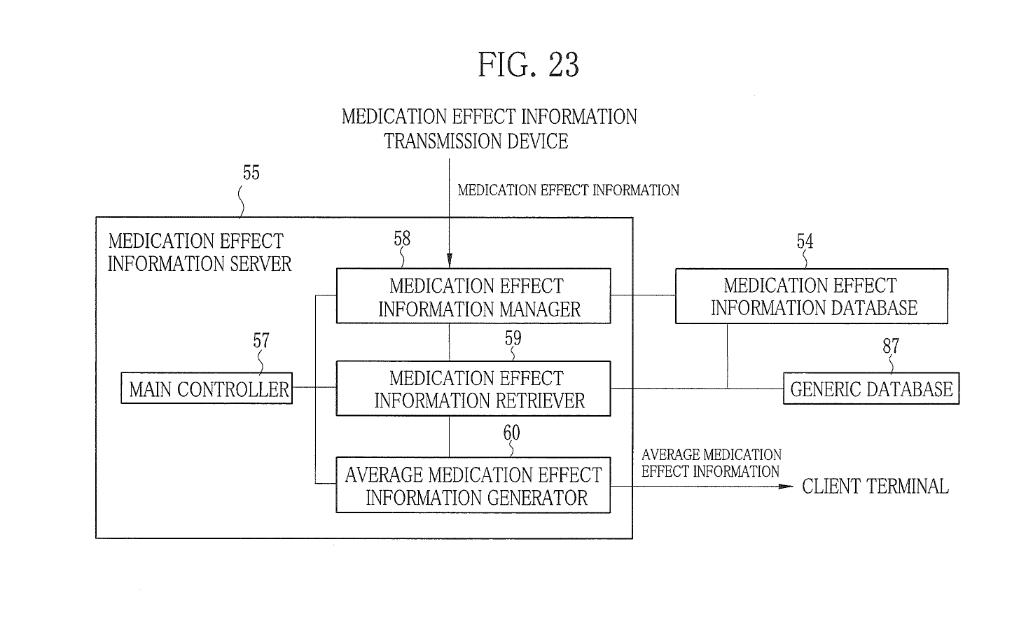

The medication effect information retriever 59 of the medication effect information server 55 retrieves the medication effect information from the medication effect information database 54 based on the retrieval conditions of the RR transmitted from the client terminal 18. At this time, as shown in FIG. 23, the medication effect information retriever 59 retrieves the generic drug corresponding to the drug (original drug) designated as the retrieval condition from a generic database 87, which stores correspondence between an original drug and a generic drug having the same or similar composition. The medication effect information retriever 59 retrieves the medication effect information of the original drug and its generic drug from the medication effect information database 54, as with the first embodiment.

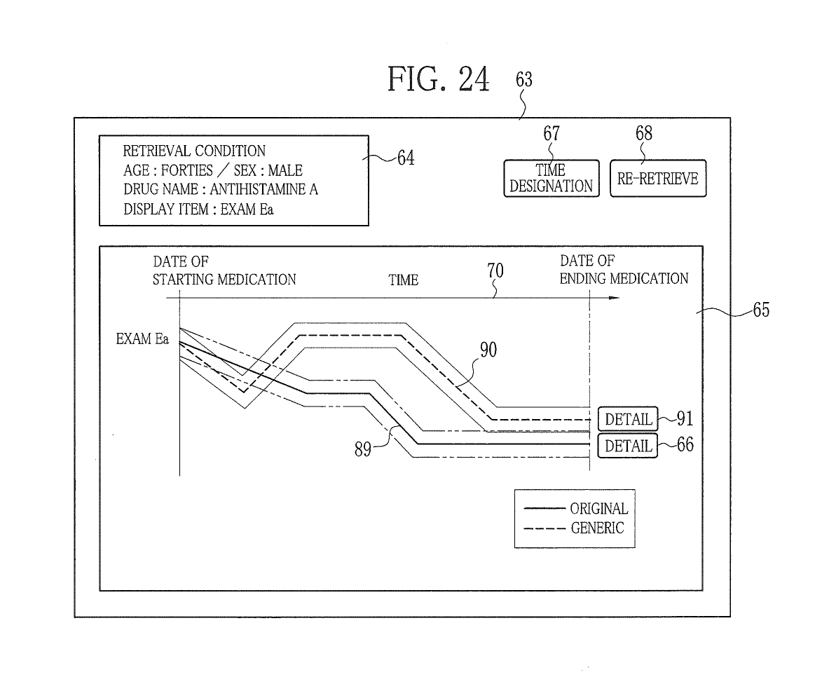

The medication effect information generator 60 produces the average medication effect information of each of the original and generic drugs from the retrieved medication effect information, and transmits the average medication effect information to the client terminal 18 that has issued the RR. The display controller 42 of the client terminal 18, as shown in FIG. 24, displays average medication effect information 89 of the original drug and average medication effect information 90 of the generic drug in the medication effect information display section 65 of the medication effect information display screen 63. By operating a detail display button 91, the medication effect information of a plurality of patients from which the average medication effect information 90 is calculated is displayed, as with the first embodiment. Also, the medication effect information at a designated time is viewed by setting a time using the time designation frame 72, which appears by operating the time designation button 67.

According to the present invention, the medication effect of the generic drug can be predicted together with the medication effect of the original drug. By contrasting the medication effect of the generic drug with the medication effect of the original drug, the generic drug becomes more usable. The patient can realize the medication effects of the generic drug and the original drug at sight, and hence easily decide which drug to use.

Although the present invention has been fully described by the way of the preferred embodiment thereof with reference to the accompanying drawings, various changes and modifications will be apparent to those having skill in this field. Therefore, unless otherwise these changes and modifications depart from the scope of the present invention, they should be construed as included therein.

What is claimed is:

1. A medication effect prediction system comprising:
a medication effect information database for storing medication effect information of past patients on a patient-by-patient basis, said medication effect information relating to attribute data of said past patient, a name of a drug administered to said past patient, and an effect of said drug on said past patient;
a medication effect information retriever for searching said medication effect information database on a basis of a name of a drug to be administered to a patient requiring treatment and attribute data of said patient requiring treatment, and obtaining said medication effect information of one or more of said past patients whose said attribute data is similar to said attribute data of said patient requiring treatment out of said past patients who took a same drug as said drug to be administered;
an average medication effect information generator for producing average medication effect information representing an average medication effect of said drug to be administered based on said medication effect information obtained by said medication effect information retriever; and
a display controller for displaying said average medication effect information in time series on a monitor.

2. The medication effect prediction system according to claim 1, wherein said average medication effect information generator lines up said medication effect information of a plurality of said past patients obtained by said medication effect information retriever at a date of starting medication in an equal time series, to calculate said average medication effect information.

3. The medication effect prediction system according to claim 2, wherein said medication effect information includes at least one of examination data and vital sign data of said past patient after administration of said drug and subjective data relating to a subjective response assessed by said past patient to an effect of administration of said drug.

4. The medication effect prediction system according to claim 2, wherein said display controller displays said average medication effect information in a graph form along a time axis.

5. The medication effect prediction system according to claim 4, wherein said display controller displays maximum and minimum values of said average medication effect information.

6. The medication effect prediction system according to claim 1, wherein said display controller displays said medication effect information of a plurality of said past patients whose said attribute data is more similar to said attribute data of said patient requiring treatment, out of said medication effect information of a plurality of said past patients used for producing said average medication effect information.

7. The medication effect prediction system according to claim 4, further comprising:
a time designator for designating arbitrary time in said average medication effect information, wherein
said display controller displays said average medication effect information of said designated time.

8. The medication effect prediction system according to claim 7, wherein said average medication effect information of said designated time includes a medical image.

9. The medication effect prediction system according to claim 8, wherein said medical image is medical images of a plurality of said past patients whose said attribute data is more similar to said attribute data of said patient requiring treatment, out of said medication effect information of a plurality of said past patients used for producing said average medication effect information.

10. The medication effect prediction system according to claim 1, wherein said medication effect information retriever retrieves a generic drug having similar composition to composition of said drug to be administered and said medication effect information of said generic drug.

11. The medication effect prediction system according to claim 10, wherein said display controller displays in said time series on said monitor said average medication effect information of said generic drug, together with said average medication effect information of said drug to be administered.

12. The medication effect prediction system according to claim 1, further comprising a medication effect information transmission device including:
a medication effect information collector for collecting said medication effect information from an electronic medical chart server, said electronic medical chart server managing said attribute data, diagnosis and treatment data, and examination data of said past patients after completion of treatment;
a standardizer for standardizing said medication effect information collected by said medication effect information collector; and
a medication effect information transmitter for transmitting said medication effect information standardized by said standardizer to a medication effect information server, said medication effect information server managing said medication effect information database.

13. The medication effect prediction system according to claim 12, wherein said medication effect information collector starts collecting said medication effect information, when a notice of medication completion for indicating completion of medication to said patient is transmitted from said electronic medical chart server.

14. A control method of a medication effect prediction system comprising the steps of:
searching a medication effect information database on a basis of a name of a drug to be administered to a patient requiring treatment and attribute data of said patient requiring treatment, and obtaining medication effect information of one or more of past patients whose attribute data is similar to said attribute data of said patient requiring treatment out of said past patients who took a same drug as said drug to be administered, said medication effect information database storing said medication effect information of said past patients on a patient-by-patient basis, said medication effect information relating to said attribute data of said past patient, said name of said drug administered to said past patient, and an effect of said drug on said past patient;
producing average medication effect information representing an average medication effect of said drug based on said obtained medication effect information; and
displaying said average medication effect information in a time series on a monitor.
